(19) United States
(12) Patent Application Publication
(10) Pub. No.: US 2006/0102089 A1
(43) Pub. Date: May 18, 2006

(54) Vivarium with distributed data terminal system

(75) Inventors: William E. Edstrom JR., Burlington, WI (US); David J. Lillie, Waterford, WI (US); Jayme Edwards, Mukwonago, WI (US); David J. Markert, Greenfield, WI (US)

Correspondence Address: QUARLES & BRADY LLP, 411 E. WISCONSIN AVENUE, SUITE 2040, MILWAUKEE, WI, 53202-4497, US

(73) Assignee: Edstrom Industries, Inc.

(21) Appl. No.: 11/247,602

(22) Filed: Oct. 11, 2005

Related U.S. Application Data
(60) Provisional application No. 60/619,307, filed on Oct. 15, 2004.

(51) Int. Cl. A01K 63/00

(52) U.S. Cl. 119/246

(57) ABSTRACT

A vivarium data management system provides for distributed terminals throughout the system for data entry and protocol review. Practical point of activity data entry and review made possible on touchscreens by tailoring the interface presented to the user closely to the user's purposes as derived from the user's role, the user's location, the function of the location, and the level of the location within the hierarchy of the vivarium structure.

### CROSS-REFERENCE TO RELATED APPLICATIONS

This application claims the benefit of U.S. provisional application 60/619,307 filed Oct. 15, 2004 hereby incorporated by reference.

### STATEMENT REGARDING FEDERALLY SPONSORED RESEARCH OR DEVELOPMENT

### BACKGROUND OF THE INVENTION

--

The present invention relates to vivariums, that is, facilities for the care of animals during research, and in particular to a vivarium providing activity-proximate data terminals to simplify and improve management of animal care, research protocols, and the collection of data.

The success of the animal research and the value of the data obtained is critically dependent on the consistency and quality of the care received by the animals as well as the timeliness and accuracy of the execution of complex research protocols. Responsibility for these tasks is normally divided among many vivarium workers ranging from those principally involved in animal care to those supervising in the research itself.

An individual worker at a vivarium will normally move between a number of vivarium locations on different floors and in different rooms during a day, for example, checking on different animals involved in different studies and subject to different protocols. The tasks performed by the worker at different locations will vary by location and over time as protocols are modified and studies change. Data collected by the worker must be clearly identified to the research with which it is associated and routed appropriately. Communication among workers is important because observations by one worker can affect the tasks that need to be performed by another.

The coordination of the activities of vivarium workers is normally provided through a combination of paper records and verbal instructions. Written research and animal care protocols and procedures can be developed and distributed to the individuals responsible for particular aspects of the protocols and procedures. In turn, these individuals provide written notes and sheets which are then transcribed into a computer database for consolidation and convenience of access.

Communication among workers is normally done on an ad hoc basis or by notes or forms posted at particular locations.

For example, written procedure sheets can be created providing a list of the tasks that need to be performed by a worker and a place for notes and observations. A set of procedure sheets for different rooms and studies may be collected, for example, on a clipboard sometimes carried by the worker as the worker moves through the facility and usually hung on the wall or back of a door in a room. Ideally, the procedure sheets are referred to and annotated at the time of the completion of each task.

While relatively simple and easy to learn, such written forms have significant drawbacks. Procedure sheets are subject to being lost and damaged, and must be vigilantly updated as studies and/or protocols change during a study. Maintaining an up-to-date set of procedure sheets for all workers is logistically complex. As a practical matter, it can be difficult to complete the sheets in the vivarium environment resulting in inaccurate, illegible, or incomplete entries—often the entire sheet goes undone resulting in collected data that cannot reliably be used by management. Transcription of written observations from a sheet into a computer is burdensome and may discourage contemporaneous data recordation in favor of direct entry of data into the computer only after the task is complete, raising a risk of inaccuracy.

### BRIEF SUMMARY OF THE INVENTION

The present invention eliminates many of the problems of managing animal care and research protocols in a vivarium by placing data terminals throughout the vivarium facility. In one embodiment, the data terminals are touchscreens which provide rugged, low maintenance cost, contamination resistant entry devices allowing contemporaneous review and recordation of data, without the need for a writing instrument, a writing surface, or skill in the use of a standard computer keyboard.

Importantly, the invention provides a simplified graphical interface having a low learning curve, rapid access speed, and largely keyboard-less entry. Such an interface is practical for the complex demands of vivarium operation by carefully tailoring each instance of the interface to the particular user, their role, and the location and purpose of the room associated with the interface. The result is a data delivery and entry system that rivals a simple printed form in ease of use, that promotes contemporaneous recordation and review of information, that allows rapid dissemination of protocol changes, promotes communication among workers, and eliminates the need for and possible errors associated with later transcription of data into an electronic form.

Specifically then, the invention may provide a vivarium having rooms housing animals in controlled environments. Multiple graphic terminals are located throughout the vivarium facility communicating with an electronic computer via a network. A program executed by the electronic computer associates the graphic terminals to particular locations in the vivarium and identifies locations to particular vivarium functions. A simplified interface screen is then delivered to a given graphic terminal based on the vivarium function associated with the location of the graphic terminal.

The vivarium function to which the interface is tailored may be a particular research study using that location or may be a general function of the location such as husbandry, surgery, animal procedures, material storage, and office space, or may indicate the equipment present at the location.

Thus, it is another object of at least one embodiment of the invention to flexibly allow a given graphic terminal to have a priori knowledge of the function and resources of the room in which it is associated so as to quickly provide for relevant interface capabilities.

Generally, the interface screen may provide information to the worker about scheduled tasks associated with the vivarium function of the location.

It is, thus, another object of at least one embodiment of the invention to provide a virtual checklist proximate to the activities likely to be performed at a particular vivarium location.

It is another object of at least one embodiment of the invention to provide centralized control of checklists that allows them to be dynamically changed from a single location without the need for duplicating paper, protocol, checklists, and the like.

The interface screen may further receive information from the worker relating to the scheduled tasks associated with the vivarium function.

It is thus another object of at least one embodiment of the invention to encourage contemporaneous data entry in electronic form eliminating the need for subsequent transcriptions.

The electronic computer may further allow vivarium workers to identify themselves as users of a given application at a given location, for example, in the log-in process, and may associate the given worker to one or more set of predefined roles required for the operation of the vivarium. The interface screen may also be customized to the role of the worker.

It is thus another object of at least one embodiment of the invention to select an interface screen that considers not only the purpose of the room, but also the particular worker interacting with the interface screen.

When the interface screen accepts input from the worker, it may provide predetermined message categories related to the worker's role.

Thus, it is another object of at least one embodiment of the invention to simplify the entry of data, eliminating the need for complex alphanumeric keyboards and the like, by providing standard messages tailored to the user and their tasks.

The information from the worker may be automatically routed to a second worker based on the message category.

Thus, it is another object of at least one embodiment of the invention to provide the ability, through the message categories, to automatically evaluate the content of the message and, thus, automatically and reliably route the information to individuals who may need to respond to the message.

More generally, the invention provides a vivarium data management system using graphic terminals positionable at locations within the vivarium. An electronic computer communicating with the terminals executes a stored program to provide for a hierarchy of locations within the vivarium facility. A list of applications providing interfaces to the vivarium workers may be linked to levels of the hierarchy to be delivered only to graphic terminals matching the levels of the hierarchy.

Thus, it is an object of at least one embodiment of the invention to provide a simple and intuitive method of tailoring an interface to particular locations, relying on the relationship of the natural architectural hierarchy of a facility, for example, campus, building, floor and room, to mirror the divisions of functions and studies of the vivarium.

It is yet another object of at least one embodiment of the invention to provide for a tailoring of interface screens beyond the function of a location, but determined by the relationship of the location to other locations.

The program may accept commands from a first user limiting the ability of a second user to change locations with which a graphic terminal is associated only to given levels of the hierarchy. The program may then accept commands from the second user to change the location with which a graphic terminal is associated as so limited.

Thus, it is an object of at least one embodiment of the invention to provide individual workers with the ability to enter data associated with locations different from the physical location of a given graphic terminal as may be necessary or convenient, yet to limit this ability to navigate through the system so as to promote contemporaneous on-site recordation of data.

The computer may further accept commands from the user allowing the user to add or subtract locations from within the hierarchy.

Thus, it is another object of at least one embodiment of the invention to provide a computerized system that is readily modified as the vivarium facility changes and new rooms are added or brought online.

The computer may accept commands from the user allowing independent naming of the levels and locations of the vivarium facility and independent naming of the fields (e.g., studies, purposes, equipment) associated with the locations.

It is thus is an object of at least one embodiment of the invention to permit the use of familiar terminology matching that used at the particular vivarium to simplify the maintenance of the changing vivarium facility and administration of the vivarium management system

The computer may provide an application program that accepts information about the equipment in each locations to allow a monitoring of equipment location and of equipment operating efficiency (for example, the percent utilization of animal housing at a given location).

Thus it is another object of the invention to make use of information from the fields normally used to filter applications to also provide inputs to the applications.

These particular objects and advantages may apply to only some embodiments falling within the claims and thus do not define the scope of the invention.

### BRIEF DESCRIPTION OF THE DRAWINGS

FIG. 1 is a phantom perspective view of an example vivarium campus employing a vivarium management system and showing in an expanded view of one room of one floor with a touchscreen terminal positioned in the room per the present invention;

FIG. 2 is a front elevational view of the touchscreen of FIG. 1 displaying an initial screen of a simplified interface per the present invention;

FIG. 3 is a block diagram of the vivarium management system of FIG. 1 in which a central computer holds a program for implementing the present invention, as well as various data files and a database, the central computer communicating over a network with a number of touchscreen terminals;

FIG. 4 is a flowchart of a portion of the program of FIG. 3 as may be used by an administrator to control the interface screens displayed by the touchscreen terminals;

FIG. 5 is a figure similar to that of FIG. 4 showing a portion of the program of FIG. 3 as may be used by vivarium workers during their rounds;

FIG. 6 is a screen display of the program of FIG. 4 for populating of a location hierarchy for use in the invention;

FIG. 7 is a screen display of the program of FIG. 4 for linking of the populated location hierarchies to particular touchscreen terminals;

FIG. 8 is a screen display of the program of FIG. 4 for linking particular users to predefined worker roles;

FIG. 9 is a screen display of the program of FIG. 4 for associating a set of tasks related to vivarium function to particular worker roles;

FIG. 10 is a screen display of the program of FIG. 4 for linking application programs to particular worker roles or fields relating to the use of a particular location type;

FIG. 11 is a screen display of the program of FIG. 4 for setting the particular roles that may use a given application;

FIG. 12 is a screen display of the program of FIG. 4 showing predefined observation categories such as may be linked to particular roles per the mechanism of the previous figures;

FIG. 13 is a screen display of the program of FIG. 5 as would be viewed by a user showing a task list presented to the user as programmed by the present invention;

FIG. 14 is a screen display of the program of FIG. 5 as would be viewed by a user allowing for the entry of notes by the user according to predefined observation categories; and

FIG. 15 is a screen display of the program of FIG. 4 controlling the navigation by a user among levels.

### DETAILED DESCRIPTION OF THE PREFERRED EMBODIMENT

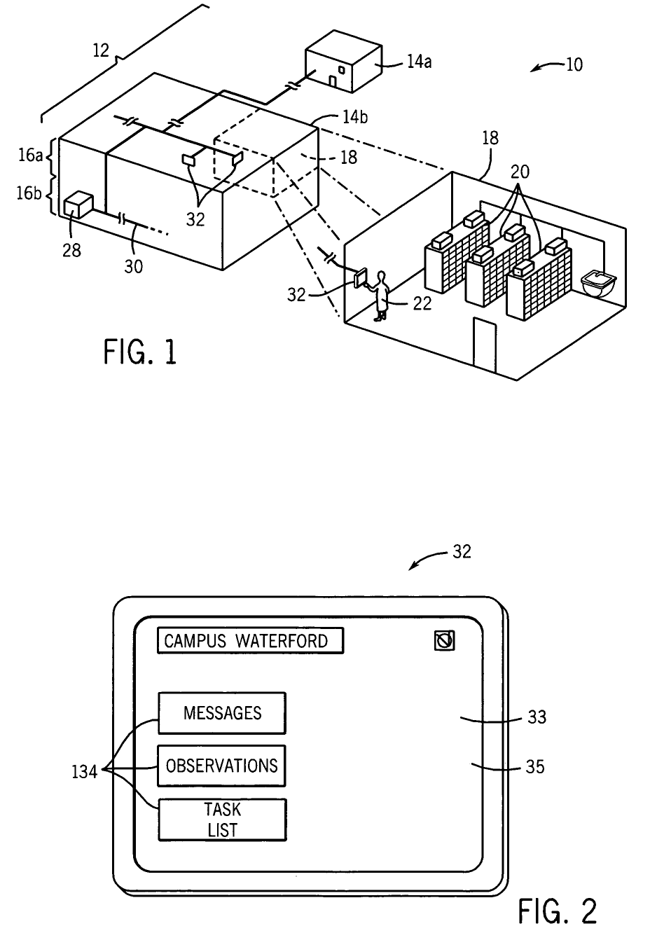

Referring to FIG. 1, a vivarium facility 10 may include a campus 12 comprising one or more buildings 14a and 14b. Each building 14 may include one or more floors 16a and 16b, the floors 16 having a plurality of rooms 18. These various levels of: campus, building, floor, and room form a natural hierarchy of the vivarium facility 10 that typically reflects its underlying organization. Ordinarily, the names, organization, and hierarchical relationship of these levels will vary among vivarium facilities 10, depending on the preferences of the operators and architecture of the vivarium facility 10.

Each of the rooms 18 of the vivarium facility may hold, for example, animal housing units 20 providing watering and ventilation systems as are generally understood in the art. More generally, the rooms 18 may be associated with a particular vivarium function, for example, husbandry, surgery, animal procedures, material storage, office space, meeting space, laboratory, maintenance, equipment washdown or particular vivarium equipment. In addition or alternatively, each room 18 may be associated with a different research study.

During the operation of the vivarium, different workers 22 will move through the rooms 18 performing different tasks associated with the vivarium. The workers 22 may have different responsibilities including but not limited to: basic animal care, veterinary care, research, supervision, and building maintenance.

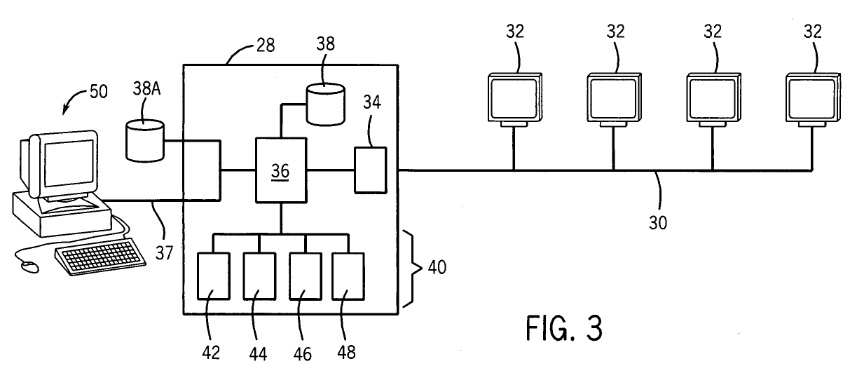

Referring now also to FIG. 3, the present invention provides a computer 28 communicating via a network 30 with a series of touchscreen terminals 32 placed at various points throughout the facility 10. Generally, touchscreen terminals 32 may be placed in each of the rooms 18, as well as in locations associated with higher levels, such as in corridors associated with particular floors 16 or in locations related to entire buildings 14 or the campus 12 as a whole. Typically, the computer 28 will be at a central location in the vivarium facility 10, but it will be understood that multiple computers may also be used and that they may be located remotely so long as they may communicate with the touchscreen terminals 32 directly or through the central computer 28

Referring to FIG. 2, each of the touchscreen terminals 32 may be a touchscreen terminal of a type known in the art providing for a graphic display surface 33 overlaid with a touchscreen membrane 35. The touchscreen membrane 35 detects the pressure of a stylus or finger on the graphic display surface 33 allowing data entry through the pressing of virtual buttons displayed on the graphic display surface 33. In a preferred embodiment, the touchscreen terminals 32 may be mounted in fixed position on a wall or the like (either on the surface or recessed into the wall) to be easily operated with gloves or a single hand from a standing position without special equipment during the normal course of a worker's duties. As mounted, the touchscreen terminal 32 may receive dedicated wiring for the network and power.

As used herein, touchscreen terminals should be understood to include those with different graphic display screen technologies including CRT- and LCD-type screens, those with different touchscreen membrane technologies including capacitive, surface acoustic wave, and resistive touchscreens, as well as such graphic displays having membrane switches on or around the display that are used in lieu of an alphanumeric keyboard, or graphic displays that use a stylus or similar instrument in place of the human finger.

The touchscreen terminal 32 may provide a seamless surface that is relatively easy to clean. Generally, the touchscreen terminal 32 does not include user exposed drive mechanisms, port connectors, operating system access, mouse, keyboard, or the like, and thus is substantially more secure and reliable, than a standard general purpose computer.

Referring again to FIG. 3, each of the touchscreen terminals 32 may run a browser program communicating on the network 30 using standard TCP/IP protocols over an Ethernet media including wirelessly, so as to provide for a robust and simple interface with the computer 28. The computer 28, in turn, may provide a server program 34 allowing it to serve information to the touchscreen terminals 32 according to well-understood Web service protocols.

The server program 34 may be controlled by management system software 36 operating to implement various features of the present invention as will be described below. Generally, the management system software 36 communicates with various data structures including a database 38 providing for storage of the various protocols and notes and observations from the workers 22. Such data would previously have been transcribed from paper notes, but in the present invention, may be entered directly from the touchscreen terminals 32.

In addition, the management system software 36 may provide an audit trail data structure contained in a remote database 38A located on the remote network 37. The audit trail is a specialized and FDA regulated data structure used to document the activities that have occurred in the vivarium.

The management system software 36 also communicates with a number of specialized data structures 40 including task lists 42, observation lists 44, worker lists 46, and facility lists 48 as will be described below. The computer 28 may also communicate over a dedicated network 37 or the network 30 with one or more administrative terminals 50 having conventional keyboards to administer the management system software 36.

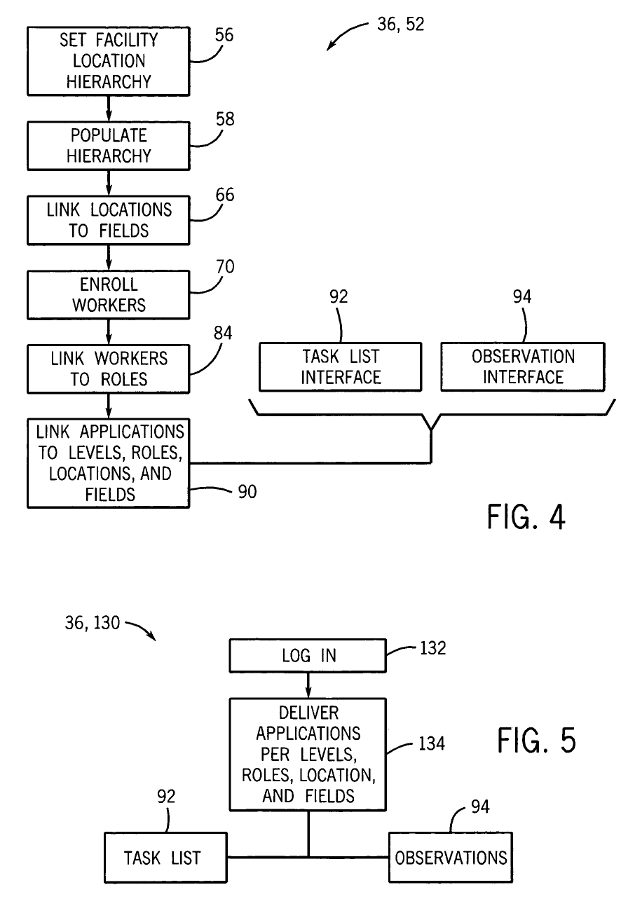

Referring now to FIG. 4, effective use of the limited data input and output capabilities of the touchscreen terminals 32, for the complex requirements of the vivarium facility 10, require a simple interface be displayed tailored to the needs of the worker 22. Accordingly, in an administrative mode 52, the management system software 36 allows the interface presented on each of the touchscreen terminals 32 to anticipate the requirements of the workers 22. This is accomplished by tailoring the interface to the location of the touchscreen terminal 32, the role being performed in the room 18 in which the touchscreen terminal 32 is located, the role of the worker 22 who is logged into the touchscreen terminal 32, and in certain circumstances, the position of the location of the touchscreen terminal 32 within the hierarchy of locations of the vivarium facility 10. These and other controlling factors will be termed “interface filter parameters”.

In the preferred embodiment, this process of delivering the focused interface screen to the terminal 32 involves choosing among particular software applications according to the interface filter parameters. However, it will be understood that this essential function can also be obtained by one or a limited set of applications that accept the interface filter parameters as arguments to dynamically generate the appropriate interface. Thus, the invention should not be limited to any particular mechanism for producing a focused-purpose interface screen that is dependent on one of these interface filter parameters.

Referring still to FIG. 4, at a first step of the administrative mode 52, a facility location hierarchy may be generated as indicated by process block 56. The facility location hierarchy provides a data structure having ordered levels and names, for example, reflecting the order and names: campus, building, floor, and room, per the hierarchy and nomenclature described with respect to FIG. 1. The facility location hierarchy reflects a natural organization structure that is intuitive and easy to understand. Generally, the number of levels and the names of the levels of the facility location hierarchy may be freely set by the user or preprogrammed by the vendor according to the user's nomenclature and facility structure.

At process block 58 the facility location hierarchy, which represents a framework only, is populated with particular units, for example, named rooms and named buildings depending on the rooms 18 and buildings 14 of the particular vivarium facility 10. This feature is accessible to the user and accommodates the fact that vivarium facilities 10 are constantly changing in organization and layout, as they must to accommodate the flexible demands of a variety of ongoing and overlapping research projects.

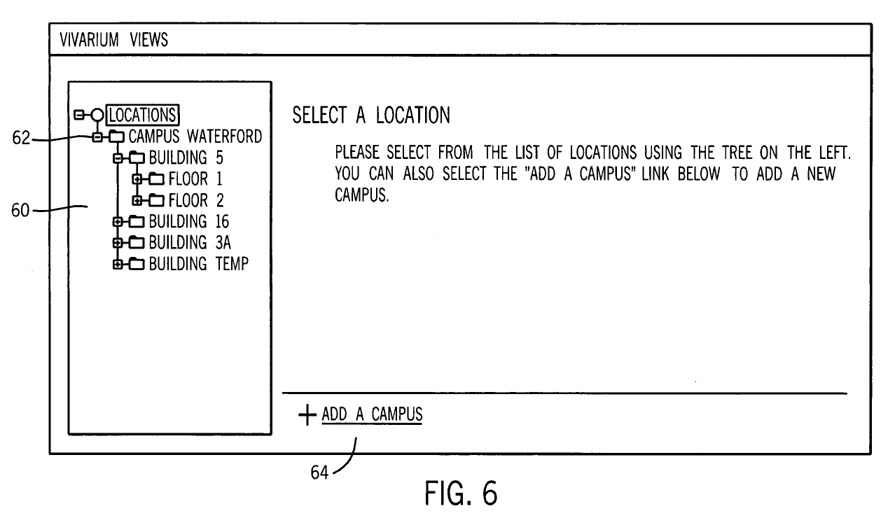

Referring to FIG. 6, the operation of process block of 58 may be accomplished through a graphic interface that displays the facility location hierarchy and it allows it to be populated to produce a tree structure 60 according to techniques well known in the art. When a particular level 62 of the tree structure 60 is highlighted, in this case the campus level, an “add a campus” button 64 becomes visible allowing the addition of a campus together with defining information about the campus and a unique name, for example, “Waterford Campus”, “Milwaukee Campus”, etc. Similarly, each of the other levels of the facility location hierarchy may have additional units added to those levels, for example, buildings, floors, etc. with the names of the buildings, floors, etc. accepted or chosen by the user.

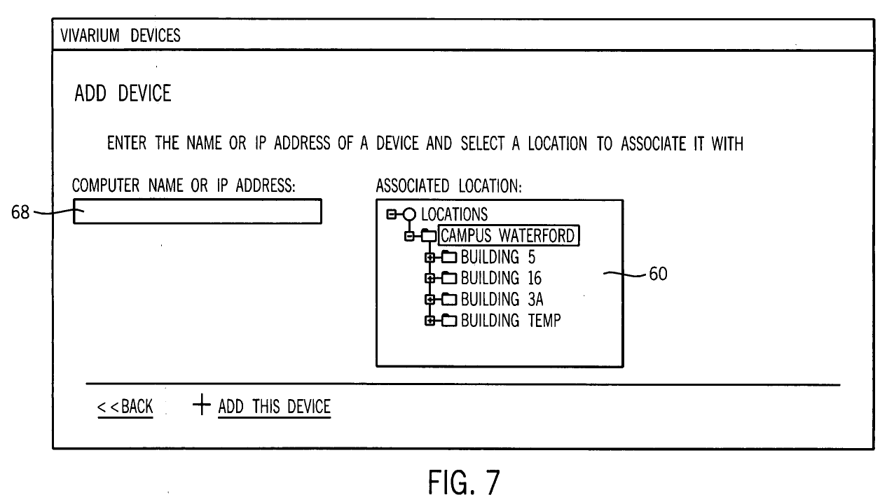

Returning again to FIG. 4, at succeeding process block 66, each graphic terminal 32 may now be linked to locations defined in the tree structure 60 of FIG. 6. As indicated by the screen of FIG. 7, the name or IP address of the terminal 32, assigned to the interface hardware of the terminal 32, is entered into textbox 68 and then linked to a particular location by highlighting elements of the tree structure 60 described above. This linkage and the facility location hierarchy data are stored in the facility lists 48 shown in FIG. 4.

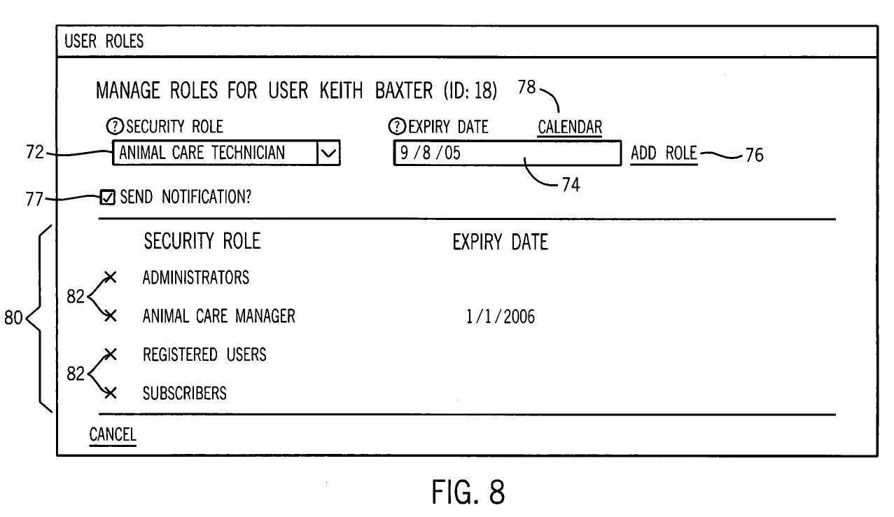

Referring to FIG. 4, at process box 70, workers 22 now may be enrolled. As shown in FIG. 8, a worker 22 is enrolled by identifying the worker's name, contact information, and other biographic data on a separate screen (not shown) and then selecting a worker 22 role from drop down menu 72 having preselected categories as will be listed later. The particular role may have an expiration date entered into text box 74 (after which time, the role is automatically dropped), and the role may be added by add role button 76 (indicated in FIG. 4 by process block 84), and the data stored in worker lists 46 (per FIG. 3) as described above. The date entry may be provided either by typing a date in or selecting it from a graphic calendar by pressing of the calendar button 78. A notification feature (activated by checkbox 77) provides an e-mail notification that the worker's role has been changed to notify the worker 22 and/or administrative personnel. Current roles assigned to the worker 22 are indicated in current role field 80 which shows the roles and their expiration dates and allows editing of them through editing buttons 82.

This information about locations, levels and worker roles will be used together with information about location purposes as interface filter parameters to deliver to the touchscreen terminals 32 interface screens that closely anticipate the data management needs of the workers 22. Two important interfaces are those associated with a task lists application 92, which presents to the worker 22 a list of tasks effecting research and animal care protocols/procedures, and the observation application 94 which allows the worker 22 to enter observations.

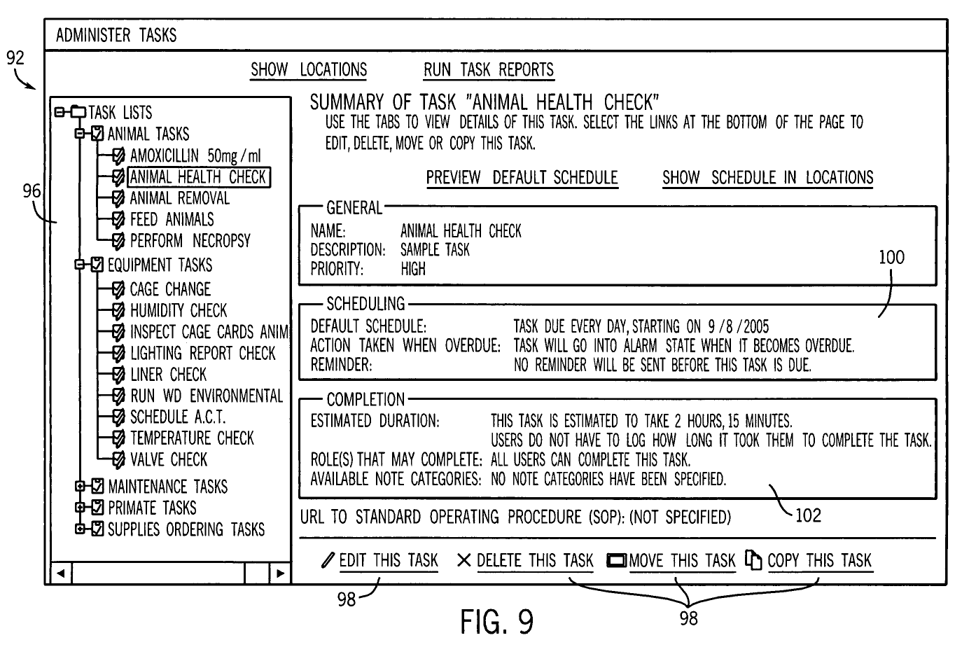

Referring now to FIG. 9, the interface for the task lists application 92 is prepared using a task tree 96 of predefined tasks including not only those related to the care of animals, but also other vivarium related tasks including those related to maintenance of equipment, ordering of supplies, monitoring of equipment and in some cases special tasks for a particular animal such as primates. Each of the tasks can be associated with a due date, warning date and other time sensitive data as indicated by schedule block 100 as well as a description, the particular worker roles that will trigger incorporation of the task into the interface screen of a terminal 32, and predefined observations (as will be described below) associated with the tasks. Generally all of this information may be edited, and the task deleted, moved or copied by buttons 98 according to editing screens as will be understood to those of ordinary skill in the art. The task data is stored in the database 38 and 38A and the linkage to particular roles, hierarchies and properties is stored in task lists 42 of FIG. 3 as previously described.

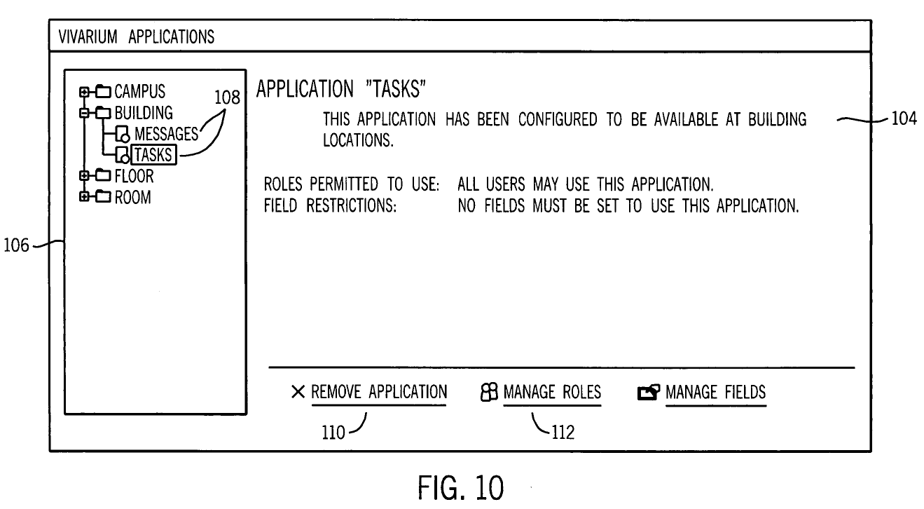

Referring now to FIG. 10, the level within the hierarchy of locations at which particular applications (and hence interface screens) are accessible may be set via a level filter screen 104 which provides a non-hierarchical tree 106 showing the location levels and a list of possible applications 108 available at those levels. Tasks may be removed or added by modification button 110 which changes from an “add application” button when a hierarchical level is highlighted to a “remove application” button when an application is highlighted. The added applications are listed under the location level.

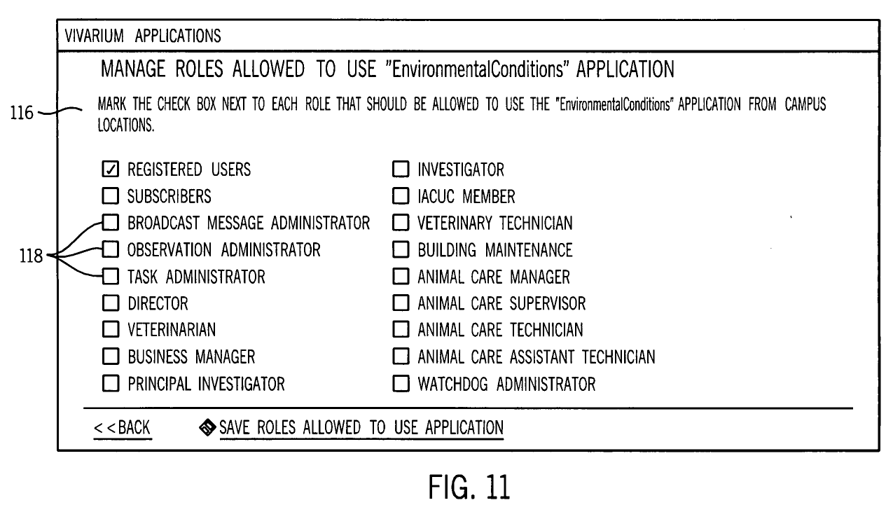

This screen also allows given applications (and hence interface screens) to be accessible only to workers 22 having particular roles (as previously associated with the workers 22) by using the “manage role” buttons 112. Referring now to FIG. 11, roles are linked to particular applications using a task role selection screen 116 providing a list of roles 118 which may be checked to associate them with the particular application. This linkage is stored in observation lists 44 or task lists 42 (per FIG. 3) as may be appropriate depending on the application.

This screen also allows given applications to be accessible only in locations having particular “fields” which may be flexibly defined to describe the purpose of the location, the equipment of the location, the research study being conducted in the location, or other location specific properties. This linkage is accomplished by pressing the “manage fields” button 114 using a screen similar to that used for linkage to worker roles as described above. These fields provide additional interface filter parameters.

Generally, the user may define the names of the fields using terminology familiar to the workers at the vivarium. This is most easily done by creating a list of user-defined terms that may be selected from a drop down list or the like.

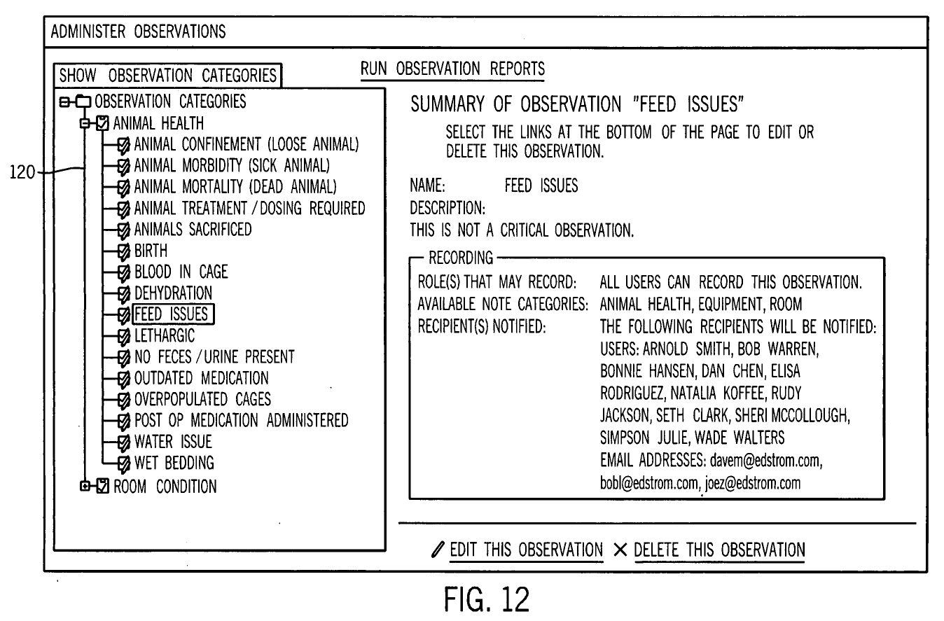

Referring now to FIG. 12, the interface filter parameters are used also to select applications (and hence interface screens) related to the input of data by a worker 22. In these applications, a set of predefined observations (held in the database 38) may be provided in observation tree 120 indicating a number of common observations that may occur. For example, one predefined observation is: “feed issues” shown as highlighted. These observations, as with other applications, may be made accessible only to particular locations, levels, worker roles and fields to efficiently limit the number of observations presented to the worker and to eliminate the need for typing. Observations may be automatically made available when particular tasks are scheduled as described above. Custom observations may also be entered by invoking a keyboard on the touchscreen for typing in custom observations, however, the intent is to prevent the need for this sort of keyboard emulation to the extent possible with the understanding that such keyboard use would be a deterrent to contemporaneous and accurate data entry at the point of care. The linkage of observations to particular hierarchies, levels, etc. is stored in observation lists 44 while the observations themselves and their context is stored in database 38 and 38A.

Referring now again to FIG. 5, after the above set up, the management system software 36 may operate in run mode 130 providing different threads to each graphic terminal 32 per conventional server client architecture. At given terminal 32, a worker 22 may login as indicated by process block 132, either by entering a simple name and password on a virtual keyboard or automatically via biometric technology such as fingerprint, palm vein, or retina readers. Non-FDA regulated applications can use technology such as bar codes or RFID tags for automatic login. After log in, the worker 22 is linked to a particular role using worker lists 46, and the location of the terminal 32 may be linked to a level and to a particular location and field using facility lists 48.

The worker role, level, location, and fields are then used in generating a narrowly tailored interface screen indicated by process block 134 such as shown in FIG. 2, providing only appropriate applications, and in identifying subsequent screens providing for example a task list of the task lists application 92 and/or an observation list of the observation application 94 using task lists 42 and observation lists 44. Note generally that the interface screen provided may be produced both by a selection of the activated applications and by a modification of the interface generated by each selected application according to the worker roles, level, location, and field. That is, the interface filter parameters may both select the particular applications available to a worker at a location, and may also provide input data to the applications that are made available. For example, an application allowing the worker to check the capacity utilization of animal housing may be available only in a room with animal housing equipment (a field) and the application may make use of the information about the animal housing contained in the field also to determined the capacity utilization of the animal housing. Similarly, the present invention may provide an application program used to locate types of equipment, the application reviewing equipment types linked to locations (as forming an interface filter parameters) to determine where particular equipment is located.

Specifically, such applications would accept input from vivarium workers to specify the capacity of equipment that can be placed in a location and the equipment capacity of specific locations. The vivarium workers would be able to specify the present utilization of equipment in a location and thereby calculate and expose the operating efficiencies of all locations that have or can have equipment. In addition, the vivarium workers may use this application to reserve a portion of equipment capacity for planned/future use; and/or removes a piece of equipment in a location.

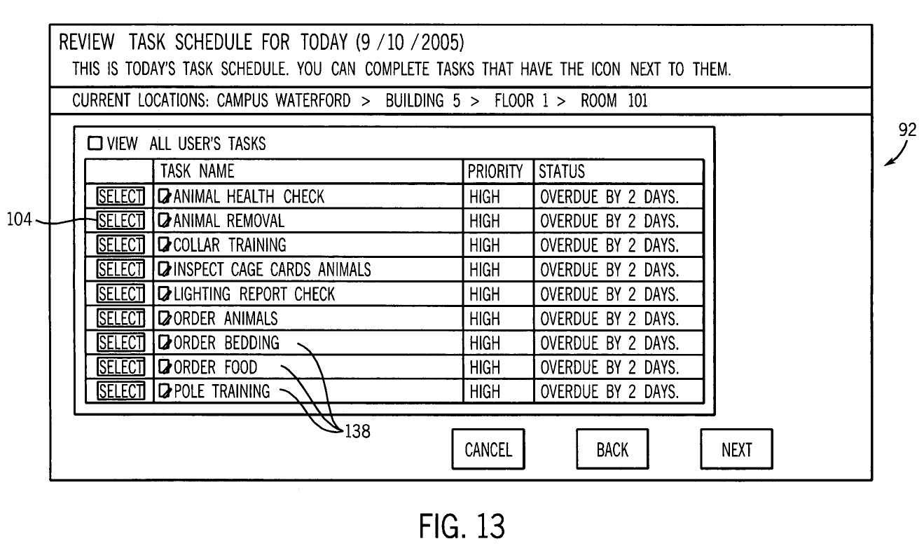

Referring now to FIG. 13, an example task list of task lists application 92 provides the worker 22 with a winnowed list of tasks 138 which must be performed at that location at that time by a worker 22 having that role. Each of these tasks has further been filtered by the time and date so that the worker 22 is presented only with tasks relevant to them at that time. The task list is generated dynamically from time data and worker roles, level, location, and field by the task list application from task data (described above) stored in the database 38 which is easily updated centrally without the need to promulgate paper copies to various workers 22.

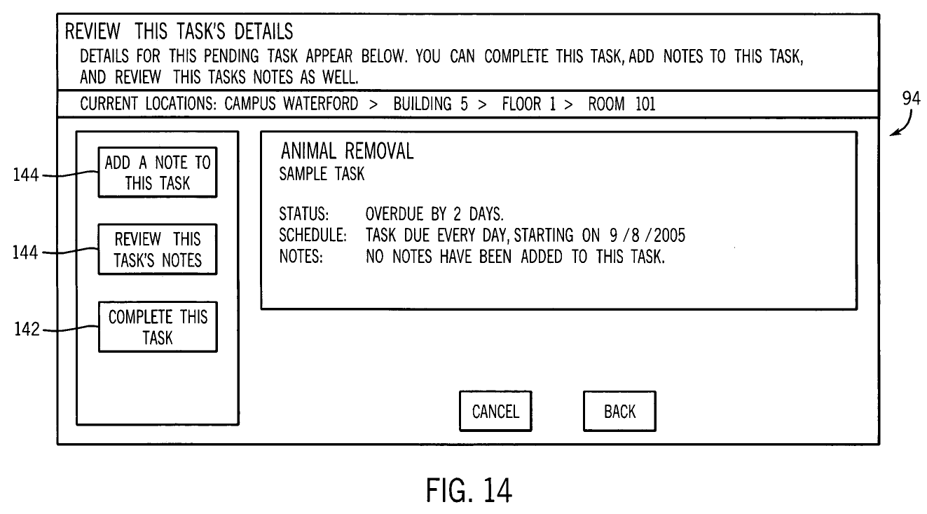

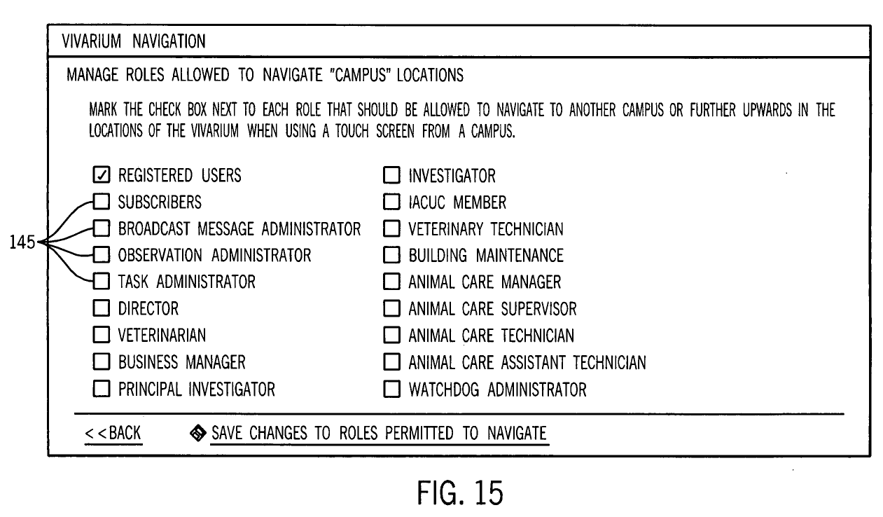

A given task may be selected by the worker 22 using select buttons 140 that provides additional information about the task per FIG. 14 and a screen that allows the task to be indicated as complete by pressing a completion button 142. This completion of the task generates data that may be stored in the database 38 and 38A providing for certifiable records upon the completion of the tasks. Tasks (as displayed in FIG. 13) may be ordered according to priority which may be established by the tasks and/or their status indicating when they were due.

Alternatively, if the worker 22 selects the observation button 144 of “add a note” as indicated in FIG. 14, a list of observations in predefined categories related to the task is presented. Because the categories have been predefined, the entered observations may be automatically sent to other workers 22 previously identified to those observations to automatically generate emails to those workers 22. These email lists may be edited per the screen described with respect to FIG. 12.

Observations may similarly be entered from the main screen shown in FIG. 2 without filtration by a particular task.

The present invention easily provides for authentication of the records both by date stamps and time stamps of the records linked to the particular worker 22 having logged on using a secure password or the like and promotes a high degree of robustness in the data by ensuring that the data is in fact recorded on site contemporaneously. Nevertheless, it may be desirable to allow the worker 22 at any terminal to check tasks or provide observations associated with locations other than the one where the worker 22 is logged on. For this purpose, the worker 22 may be allowed to “navigate” through the locations of the vivarium effectively changing the location associated with the particular terminal 32 on a temporary basis through the use of appropriate navigation buttons generally moving the worker up and down the facility location hierarchy and laterally within levels.

This ability to navigate throughout the system nevertheless may be controlled as indicated in FIG. 16 by an administrative screen that for any given level, for example “campus”, as shown in FIG. 16, limits workers 22 by roles in their ability to move to other campuses or further upward in the hierarchy. Workers 22 are selected through a series of menu buttons 145. Thus, for example, some workers 22 may be prevented from navigation at all or may be able to navigate only among rooms, but not upward from that position.

It is specifically intended that the present invention not be limited to the embodiments and illustrations contained herein, but include modified forms of those embodiments including portions of the embodiments and combinations of elements of different embodiments as come within the scope of the following claims.

We claim:

1. A vivarium comprising:
a vivarium facility including rooms housing animals in controlled environments;
multiple graphic terminals at locations throughout the vivarium facility;
an electronic computer communicating via a network with the graphic terminals and executing a stored program to:
(a) identify locations to one of a set of vivarium functions;
(b) associate the graphic terminals to locations;
(c) deliver a simplified interface screen to a given graphic terminal based on the vivarium function of a given location; and
(d) exchange data related to the vivarium function directly with a worker at the given location using the interface screen on the given graphic terminal.

2. The vivarium of claim 1 wherein the vivarium function is an identified research study using the location.

3. The vivarium of claim 1 wherein the vivarium function is a function selected from the group consisting of: husbandry, surgery, animal procedure, storage, meeting space, laboratory, maintenance, equipment washdown, and office space.

4. The vivarium of claim 1 wherein the interface screen provides information to the worker about scheduled tasks associated with the vivarium function of the location.

5. The vivarium of claim 1 wherein the interface screen receives information from the worker about scheduled tasks associated with the vivarium function.

6. The vivarium of claim 1 wherein the electronic computer further executes to:
allow vivarium workers identifying themselves as a user of a given graphic terminal;
link the given worker to one or more of a set of roles associated with an operation of the vivarium; and
wherein the delivery of the simplified interface screen to the worker is also based on the role of the worker.

7. The vivarium management system of claim 1 wherein the graphic terminal is fixed at the location.

8. A vivarium comprising:
a vivarium facility including rooms housing animals in controlled environments;
multiple graphic terminals at locations throughout the facility;
an electronic computer communicating via a network with the graphic terminals and executing a stored program to:
(a) allow vivarium workers to log on to the graphic terminals identifying a given worker to a given graphic terminal;
(b) link the given worker to one or more of a set of roles associated with an operation of the vivarium;
(c) deliver a simplified interface screen to the given graphic terminal based on the role of the worker; and
(d) exchange data related to the role of the worker directly with the worker at the location using the interface screen on the given graphic terminal.

9. The vivarium of claim 8 wherein the interface screen provides information to the worker about tasks associated with the operation of the vivarium related to the role of the worker.

10. The vivarium management system of claim 8 wherein the interface screen receives information from the worker about tasks associated with the worker's role at the location.

11. The vivarium management system of claim 10 wherein the interface screen provides predetermined message categories for information from the worker, the message categories being a function of the worker's role.

12. The vivarium management system of claim 11 wherein the information from the worker is automatically routed to a second worker based on the message category.

13. The vivarium management system of claim 8 wherein the stored program further executes to:
identify a location of the graphic terminal; and
wherein the delivery of the simplified interface screen to the worker is based on the location of the graphic terminal.

14. A vivarium data management system comprising:
a plurality of graphic terminals positionable at locations within a vivarium facility;
an electronic computer communicating with the terminals and executing a stored program to:
(a) provide a hierarchy of locations forming components of the vivarium facility;
(b) provide a list of applications related to the management of vivarium operations displayable on the graphic terminals;
(c) accept commands from a user linking the applications to levels of the hierarchy; and
(d) operate to deliver the applications to graphic terminals associated with locations matching the levels of the hierarchy.

15. The vivarium management system of claim 14 wherein the levels are selected from the group consisting of campus, building, floor and room.

16. The vivarium management system of claim 14 further accepting commands from a user linking the applications to location properties, and wherein the applications are delivered to graphic terminals at locations also matching the location properties;
wherein property is selected from the group consisting of the vivarium function performed at the location and a research study associated with animals of the location.

17. The vivarium management system of claim 14 further accepting commands from a user linking the applications to worker roles; and
wherein the applications are delivered to graphic terminals at locations also matching the location properties.

18. The vivarium management system of claim 14 wherein the electronic computer further executes the stored program to:
accept commands from a first user limiting an ability of a second user to change the location with which a graphic terminal is associated to given levels of the hierarchy; and
accept commands from the second user to change the location with which a graphic terminal is associated as so limited.

19. The vivarium management system of claim 14 wherein the electronic computer further accepts commands from a user adding and subtracting locations within the hierarchy.

20. The vivarium management system of claim 14 wherein the electronic computer further accepts commands from the user allowing independent naming of the levels and naming of the locations.

21. A computer program fixed in a tangible medium for management of a vivarium having a vivarium facility including rooms housing animals in controlled environments and multiple graphic terminals at locations throughout the facility, the computer program operating on an electronic computer communicating via a network to:
(a) identify locations to one of a set of vivarium functions;
(b) associate the graphic terminals to locations;
(c) deliver a simplified interface screen to a given graphic terminal based on the vivarium function of the given location; and
(d) exchange data related to the vivarium function directly with a worker at the location using the interface screen on the given graphic terminal.

22. A computer program fixed in a tangible medium for management of a vivarium having a vivarium facility including rooms housing animals in controlled environments and multiple graphic terminals at locations throughout the facility, the computer program operating on an electronic computer communicating via a network to:
(a) accept input from vivarium workers to log on to the graphic terminals identifying a given worker;
(b) link the given worker to one of a set of roles associated with an operation of the vivarium;
(c) deliver a simplified interface screen to the graphic terminal based on the linked role; and
(d) exchange data related to the role of the given worker directly with the given worker at the location using the interface screen on the graphic terminal.

23. A computer program fixed in a tangible medium for management of a vivarium having a vivarium facility including rooms housing animals in controlled environments and multiple graphic terminals at locations throughout the facility, the computer program operating on an electronic computer communicating via a network to:
(a) accept input from vivarium workers to specify the capacity of equipment that can be placed in a location;
(b) accept input from vivarium workers to specify the equipment capacity of specific locations;
(c) accept input from vivarium workers to specify the present utilization of equipment in a location;
(d) calculate and expose the operating efficiencies of all locations that have or can have equipment.
(e) accept input from vivarium workers to reserve a portion of equipment capacity for planned/future use; and
(f) accept input from vivarium workers that places and/or removes a piece of equipment in a location.
